(19) United States
(12) Patent Application Publication
(10) Pub. No.: US 2023/0306846 A1
(43) Pub. Date: Sep. 28, 2023

(54) DYNAMIC PARKING MANAGEMENT SYSTEM

(71) Applicant: International Business Machines Corporation, Armonk, NY (US)

(72) Inventors: Yohkichi Sasatani, Yokohama-city (JP); Takeshi Watanabe, Kawasaki (JP); Sanehiro Furuichi, Setagaya-ku (JP)

(21) Appl. No.: 17/654,081

(22) Filed: Mar. 9, 2022

(51) Int. Cl. G08G 1/14

(52) U.S. Cl. CPC G08G 1/141; G08G 1/146

(57) ABSTRACT

Computer hardware and/or software configured to determine a plurality of parking spaces on a roadway within a pre-defined geographic location, wherein the plurality of parking spaces are available parking spaces on a side of the roadway, determine a plurality of autonomous vehicles to be parked within the pre-defined geographic location, allocate a selected parking space from the plurality of parking spaces to an autonomous vehicle of the plurality of autonomous vehicles, and transmit parking space information to the autonomous vehicle, wherein the parking space information includes the selected parking space.

### BACKGROUND OF THE INVENTION

The present invention relates generally to autonomous vehicles, and more particularly to parking management of autonomous vehicles.

An automated driving system is generally an integrated package of individual automated systems operating in concert. Automated driving implies that a driver has delegated the ability to drive (e.g., appropriate monitoring, agency, and action functions) to the vehicle automation system. Even though the driver may be alert and ready to act at any moment, the automation system controls all functions.

Automated driving systems are often conditional, meaning that the automation system is capable of automated driving, but not for all conditions encountered during normal operation. Therefore, a human driver typically initiates the automated driving system, and may or may not do so when driving conditions are within the capability of the automation system.

Autonomous vehicles, such as autonomous passenger cars, may provide the capability to transport users from a first location to a second location. Autonomous passenger cars may provide the capability to be utilized as personal vehicles. Fully autonomous (i.e., self-driving vehicles) vehicles may provide the capability to drive users from one location to another, instead of users actively participating in the driving. These self-driving vehicles may ultimately integrate onto roadways with other vehicles capable of some level of driver assistance technology. This may include vehicles ranging from traditional non-automated, where a fully engaged driver is present during operation, vehicles, to fully autonomous vehicles, where a self-driving vehicle operates independently, without a human driver.

### SUMMARY

Aspects of an embodiment of the present invention disclose a method, computer program product, and computer system. The method includes determining, by the one or more computer processors, a plurality of parking spaces on a roadway within a pre-defined geographic location, wherein the plurality of parking spaces are available parking spaces on a side of the roadway. The method further includes determining, by the one or more computer processors, a plurality of autonomous vehicles to be parked within the pre-defined geographic location. the method further includes allocating, by the one or more computer processors, a selected parking space from the plurality of parking spaces to an autonomous vehicle of the plurality of autonomous vehicles. The method further includes transmitting, by the one or more computer processors, parking space information to the autonomous vehicle, wherein the parking space information includes the selected parking space.

### BRIEF DESCRIPTION OF THE DRAWINGS

FIG. 1 illustrates a data processing environment, generally designated 100, in accordance with an embodiment of the present invention.

FIG. 2 is a flowchart depicting operational steps of a parking management program, such as the parking management program of FIG. 1, generally designated 200, for providing dynamic parking space management for an autonomous vehicle on a roadway, in accordance with an embodiment of the present invention.

FIG. 3 is a block diagram depicting components of a data processing environment, such as the server of FIG. 1, generally designated 300, in accordance with an embodiment of the present invention.

### DETAILED DESCRIPTION

Embodiments of the present invention recognize that a fully autonomous vehicle does not need to be parked continuously in the same place and can be moved to various parking spaces automatically depending on certain situations. For example, a shared autonomous vehicle other than an autonomous private vehicle may be parked anywhere when not in use, provided it is moved as needed. Embodiments of the present invention recognize that when there are more fully autonomous vehicles capable of unmanned travel a use state of a roadway becomes clear and a roadway having less traffic demand can be utilized for other purposes, such as on roadway parking. For example, by using a part of a roadway as a parking lot for autonomous vehicles, efficient use of the roadway can be realized.

Embodiments of the present invention provide the capability to configure a part of a roadway (e.g., all lanes or a part of a lane) with less traffic demand to be used as a parking space targeted for autonomous vehicles. Embodiments of the present invention provide the capability to select a roadway having less traffic movement and a shape suitable location for setting up a parking space based on information of an autonomous vehicle requesting parking and roadway information. Embodiments of the present invention provide the capability to predict traffic congestion and select a part of a roadway as a location for a parking space. Embodiments of the present invention provide the capability to set up a parking space on demand in response to one or more parking requests and may secure a parking space beforehand based on a parking demand prediction. Embodiments of the present invention provide the capability to dynamically modify autonomous vehicle parking space allocations to a parking space. Embodiments of the present invention provide the capability to instruct an autonomous vehicle requesting parking to move to a nearby temporary parking lot to park. Embodiments of the present invention provide the capability to change a capacity or location of a temporary parking lot based on a congestion prediction, and further secure a new parking lot and instruct autonomous vehicles in a temporary parking space to move. Embodiments of the present invention provide the capability to optimize a size occupied by a parking space to be configured as small as possible utilizing a default inter-vehicle distance. Some embodiments of the present invention provide the capability to provide a temporary parking lot for conventional vehicles by loading the conventional vehicles into an autonomous vehicle transportation trailer, and then instructing the autonomous vehicle transportation trailer to locate to a parking space.

Implementation of such embodiments may take a variety of forms, and exemplary implementation details are discussed subsequently with reference to the Figures.

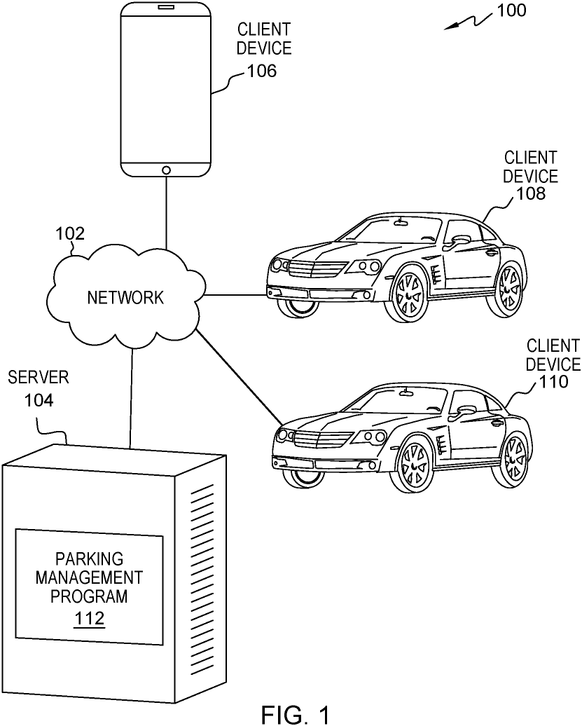

Referring now to various embodiments of the invention in more detail, FIG. 1 is a functional block diagram that illustrates a data processing environment, generally designated 100, suitable for providing dynamic parking space management for an autonomous vehicle on a roadway, in accordance with at least one embodiment of the invention. The present invention will now be described in detail with reference to the Figures. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. FIG. 1 includes network 102, server 104, and one or more client devices, such as client device 106, client device 108, and client device 110.

In one embodiment, network 102 is the Internet representing a worldwide collection of networks and gateways that use TCP/IP protocols to communicate with one another. Network 102 may include wire cables, wireless communication links, fiber optic cables, routers, switches and/or firewalls. Server 104, client device 106, client device 108, and client device 110 are interconnected by network 102. Network 102 can be any combination of connections and protocols capable of supporting communications between server 104, client device 106, client device 108, client device 110, and parking management program 112. Network 102 can be, for example, a telecommunications network, a local area network (LAN), a virtual local area network (VLAN), a wide area network (WAN), such as the Internet, or a combination of the three, and can include wired, wireless, or fiber optic connections. Network 102 may include one or more wired and/or wireless networks that are capable of receiving and transmitting data, voice, and/or video signals, including multimedia signals that include voice, data, and video information, and location data, including global positioning system (GPS) data, etc. In general, network 102 may be any combination of connections and protocols that will support communications between server 104, client device 106, client device 108, client device 110, and parking management program 112, as well as other computing devices and servers (not shown) within data processing environment 100. FIG. 1 is intended as an example and not as an architectural limitation for the different embodiments.

In one embodiment, server 104 may be, for example, a server computer system such as a management server, a web server, or any other electronic device or computing system capable of sending and receiving data. In another embodiment, server 104 may be a data center, consisting of a collection of networks and servers providing an IT service, such as virtual servers and applications deployed on virtual servers, to an external party. In another embodiment, server 104 represents a “cloud” of computers interconnected by one or more networks, where server 104 is a computing system utilizing clustered computers and components to act as a single pool of seamless resources when accessed through network 102. This configuration may be implemented for data centers in addition to cloud computing applications. In one embodiment, server 104 includes parking management program 112 for providing dynamic parking space management for an autonomous vehicle on a roadway.

In one embodiment, parking management program 112 operates on a central server, such as server 104, and can be utilized by one or more client devices, such as client device 106, client device 108, and client device 110, via an application download from the central server or a third-party application store and executed on the one or more client devices. In another embodiment, parking management program 112 may be software, downloaded from a central server, such as server 104, and installed on one or more client devices, such as client device 106, client device 108, and client device 110. In yet another embodiment, parking management program 112 may be utilized as a software service provided by a third-party cloud service provider (not shown). In yet another embodiment, parking management program 112 may include one or more components (not shown), such as add-ons, plug-ins, and agent programs, etc., installed on one or more client devices, such as client device 106, client device 108, and client device 110, for providing dynamic parking space management for an autonomous vehicle on a roadway. In one embodiment, parking management program 112 can be an add-on feature to a logistics service that provides the capability to dynamically manage parking space allocation for an autonomous vehicle on a roadway. In one embodiment, parking management program 112 can be fully integrated with one or more autonomous vehicles, such as client device 108 and client device 110. In some embodiments, parking management program 112 may be partially integrated or separate from an autonomous vehicle transportation service, such as a transportation service that can transport a user from a first location to a second location utilizing an autonomous vehicle. In one embodiment, parking management program 112 can be an add-on feature for a conventional navigation system (not shown), where the add-on feature enables an autonomous vehicle to dynamically manage parking space allocation on a roadway. In one embodiment, parking management program 112 can be fully integrated with a conventional navigation system integrated with an autonomous vehicle, such as client device 108 and client device 110. In some embodiments, parking management program 112 may be partially integrated or separate from a conventional navigation system integrated with an autonomous vehicle, such as client device 108 and client device 110. In one embodiment, parking management program 112 may be an application, downloaded from an application store or third-party provider, capable of being used in conjunction with parking management tools integrated with one or more client devices, such as client device 106 to dynamically manage parking space allocation on a roadway for one or more autonomous vehicles, such as client device 108 and client device 110.

In one embodiment, parking management program 112 can be utilized by a client device, such as client device 106, to dynamically manage parking space allocation on a roadway for one or more autonomous vehicles, such as client device 108 and client device 110. In one embodiment, parking management program 112 provides the capability to, based on a received request from a user via a mobile device, such as client device 106, for a parking space allocation on a roadway, instruct one or more autonomous vehicles, such as client device 108 and client device 110, to locate to an available parking space on a roadway and park within the available parking space. In one embodiment, parking management program 112 provides the capability to communicate available parking space allocations within a pre-determined geographic boundary surrounding the autonomous vehicle, such that one or more users of the autonomous vehicle and/or the autonomous vehicle, such as client device 108 and client device 110, can view and request parking space allocations along one or more roadways. In one embodiment, parking management program 112 provides the capability to communicate and exchange location information between a plurality of autonomous vehicles, such that the autonomous vehicles can collaborate during parking space management activities on a roadway.

In one embodiment, parking management program 112 may include one or more integrated components for dynamically managing parking space allocation on a roadway. In one embodiment, parking management program 112 may include a parking demand prediction component (not shown) that provides the capability to predict an autonomous vehicle to be parked in the future by obtaining historical data (e.g., historical metadata and information) related to prior parking requests from stored vehicle service information held in a vehicle service database (not shown) and creating a time series prediction of a plurality of autonomous vehicles requesting parking. In one embodiment, parking management program 112 may include a congestion detection prediction component (not shown) that provides the capability to determine whether there is currently traffic congestion forward and rearward of an existing parking space utilizing a traffic information and prediction information database (not shown) and predict a rate of congestion by considering the existing parking space and related travel history of the vehicle from a vehicle travel information database (not shown). In one embodiment, parking management program 112 may include a parking space management component (not shown) that provides the capability to conduct retrieval of vehicle information and vehicle service information, monitoring existing available parking spaces on a roadway, determining a vehicle to be parked in at least one of the existing available parking spaces on the roadway, allocating at least one of the existing available parking spaces on the roadway to a vehicle to be parked, transmitting parking space information and vehicle service information to a plurality of autonomous vehicles, the vehicle service database, and the vehicle travel information database, and adjusting the available parking spaces on the roadway based on parking space allocations and rates of congestion on the roadway. In one embodiment, parking management program 112 may include a transmitting part (not shown) and a receiving part (not shown) that provides the capability to transmit parking space information and vehicle service information to a plurality of autonomous vehicles and databases, and receive vehicle information and vehicle service information from the plurality of autonomous vehicles.

In one embodiment, parking management program 112 may be configured to access various data sources, such as a variety of databases or repositories (not shown), that may include personal data, content, contextual data, vehicle data, vehicle service information, vehicle travel information, location information, or any other information a user may not wish to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Parking management program 112 enables the authorized and secure processing of personal data. In various embodiments, parking management program 112 obtains informed consent from the user, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In another embodiment, parking management program 112 provides information regarding personal data and the nature (e.g., type, scope, purpose, duration, etc.) of the processing. In various embodiments, parking management program 112 provides a user with copies of stored personal data. In various embodiments, parking management program 112 allows the correction or completion of incorrect or incomplete personal data. In various embodiments, parking management program 112 allows the immediate deletion of personal data.

In one embodiment, client device 106 is a client to server 104 and may be, for example, a desktop computer, a laptop computer, a tablet computer, a personal digital assistant (PDA), a smart phone, a thin client, or any other electronic device or computing system capable of communicating with server 104 through network 102. For example, client device 106 may be a mobile device, such as a smart phone, capable of connecting to a network, such as network 102, to access the Internet, utilize one or more communication tools, and utilize one or more software applications to dynamically manage parking space allocation for an autonomous vehicle, such as client device 108 and client device 110. In one embodiment, client device 106, may be any suitable type of client device capable of executing one or more applications utilizing a mobile operating system or a computer operating system. In one embodiment, client device 106 may include a user interface (not shown) for providing a user with the capability to interact with parking management program 112 and one or more autonomous vehicles, such as client device 108 and client device 110. A user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In one embodiment, client device 106 may be any wearable electronic device, including wearable electronic devices affixed to eyeglasses and sunglasses, helmets, wristwatches, clothing, wigs, tattoos, embedded devices, and the like, capable of sending, receiving, and processing data. In one embodiment, client device 106 may be any wearable computer capable of operating a computer program, such as parking management program 112, capable of providing dynamic parking space management for an autonomous vehicle on a roadway. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In general, client device 106 may represent one or more programmable electronic devices or combination of programmable electronic devices capable of executing machine readable program instructions and communicating with other computing devices (not shown) within data processing environment 100 via a network, such as network 102. In one embodiment, client device 106 may be integrated into an autonomous vehicle, such as client device 108 and client device 110. For example, client device 106 may include a heads-up display (HUDS) integrated into a dashboard of an autonomous vehicle, such as client device 108 and client device 110, to project an image on a windshield of the autonomous vehicle.

In one embodiment, client device 108 and client device 110 represent an autonomous vehicle, such as a self-driving motor vehicle (e.g., a car, a bus, a box truck, a van, a motorcycle, a scooter, etc.), deployed by an owner/operator for transporting one or more users from a first location to one or more additional locations. In one embodiment, client device 108 and client device 110 may be an autonomous vehicle deployed by a transportation service provider for transporting customers from a first location to one or more additional locations. In one embodiment, client device 108 and client device 110 may be any type of autonomous vehicle capable of fully autonomous operation. In one embodiment, client device 108 and client device 110 represent an autonomous vehicle, such as an autonomous passenger car, capable of receiving instructions from a user device, such as client device 106, for locating to a parking space one a roadway. In one embodiment, client device 108 and client device 110 may represent an autonomous vehicle having any level of autonomous integration (e.g., Level 3, Level 4, Level 5), such as constrained autonomy through full driverless autonomy.

In one embodiment, client device 108 and client device 110 may include one or more components for dynamically managing parking space allocation on a roadway. In one embodiment, the one or more components of client device 108 and client device 110 provide the capability to receive parking space information and vehicle service information from a parking management program, such as parking management program 112, optimize a position of parking (e.g., distance between parked autonomous vehicles, distance from an autonomous vehicle to a pre-determined boundary of a parking space, distance from an autonomous vehicle to a shoulder of a roadway, etc.) within a parking space on a roadway, and transmit vehicle information and vehicle service information to a parking management program, such as parking management program 112. In one embodiment, client device 108 and client device 110 may include a parking space control component (not shown) that provides the capability to obtain geographical information and inter-vehicle distance information in a parking space utilizing parking space information, and instruct an autonomous vehicle, such as client device 108 and client device 110, to travel toward a pre-defined position within a parking space. In one embodiment, client device 108 and client device 110 may include a transmitting part (not shown) and a receiving part (not shown) that provides the capability to transmit vehicle information and vehicle service information from the autonomous vehicle to a parking management program, such as parking management program 112, and receive parking space information and vehicle service information from a parking management program, such as parking management program 112.

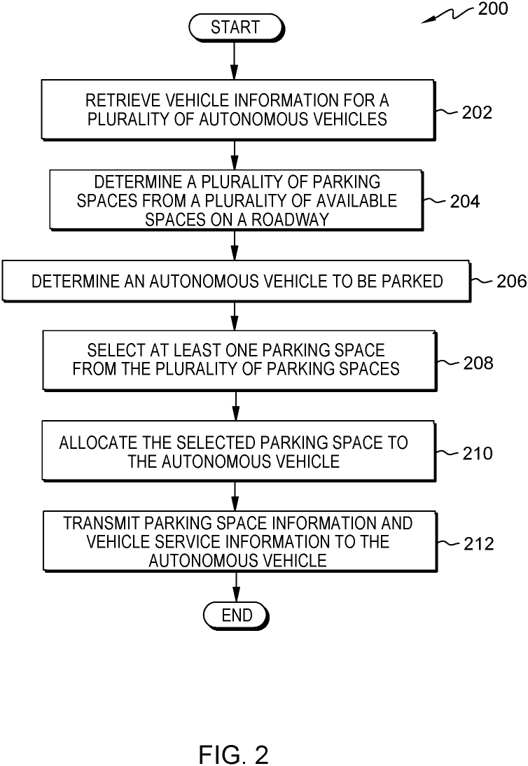

FIG. 2 is a flowchart depicting operational steps of a parking management program, such as parking management program 112, generally designated 200, for dynamically managing parking space allocation on a roadway for one or more autonomous vehicles, in accordance with an embodiment of the present invention.

Parking management program 112 retrieves vehicle information for a plurality of autonomous vehicles (202). In one embodiment, parking management program 112 retrieves vehicle information for a plurality of autonomous vehicles, wherein the vehicle information includes a state of location for each of the plurality of autonomous vehicles within a pre-defined geographical boundary. In one embodiment, parking management program 112 retrieves vehicle information actively from the plurality of autonomous vehicles within a pre-defined geographic boundary utilizing a vehicle communication component enabled over network or similar device pairing capability. In another embodiment, parking management program 112 may retrieve vehicle information for the plurality of autonomous vehicles passively, utilizing a vehicle information and vehicle service information component to retrieve the vehicle information from a vehicle travel information database. In one embodiment, vehicle information may include vehicle user information, including, but not limited to, a user profile and one or more user preferences, and vehicle service information (i.e., vehicle history), including, but not limited to, prior parking requests, a parking state (i.e., currently parked, not currently parked, traveling, etc.), one or more parking space allocations, a current location of the autonomous vehicle, a waiting start time, and a waiting end time. In one embodiment, parking management program 112 records vehicle information in a vehicle service database for future reference.

Parking management program 112 determines a plurality of parking spaces from a plurality of available parking spaces on a roadway (204). In one embodiment, parking management program 112 determines a plurality of parking spaces from a plurality of available parking spaces on a roadway by determining whether there are any existing available parking spaces on the roadway. In one embodiment, the plurality of available parking spaces are parking locations on a side of the roadway. In one embodiment, the plurality of available parking spaces are parking locations in a median of the roadway. In one embodiment, the plurality of available parking spaces are parking locations in a dedicated parking lane on a roadway. In one embodiment, parking management program 112 references a parking space database to retrieve parking space information within a pre-defined geographic location. For example, parking space information includes, but is not limited to, a geographical location of a parking space, a parking space dimension (e.g., a center position of the parking space, a perimeter of the parking space, an area of the parking space, a maximum size of the parking space, etc.), an inter-vehicle distance (e.g., left to right distance, front to back distance) between two parked autonomous vehicles, a number of autonomous vehicles that can be parked, a number of available parking spaces for a plurality of autonomous vehicles, and a parking space allocation status (e.g., allocated, not allocated). Where parking management program 112 determines that there is at least one existing available parking space on a roadway, parking management program 112 further determines whether there is currently traffic congestion before and behind the existing parking space by referencing a traffic information/prediction information database for information indicating current traffic congestion (e.g., delayed travel times, slower vehicle speeds, etc.). In one embodiment, parking management program 112 may predict a future rate of congestion by considering the existing available parking space and referencing associated travel history data of an autonomous vehicle and associated travel history data of the roadway from a vehicle travel information database. Where parking management program 112 determines that there is currently traffic congestion or predicts a future rate of congestion, parking management program 112 deletes information related to the existing parking space from a parking space database and deletes any prior allocations of the existing parking space to an autonomous vehicle. In one embodiment, parking management program 112 may cancel an existing parking space and dynamically change allocation of parking space to a vehicle based, at least in part, upon occurrence of traffic congestion or a prediction of traffic congestion. Where parking management program 112 determines that there a rate of congestion is below a pre-determined acceptable congestion threshold, parking management program 112 retains information related to the existing parking space in a parking space database and flags the existing parking space as available for allocation.

In one embodiment, where parking management program 112 determines that there are no existing available parking spaces on a roadway, parking management program 112 determines a new parking space within the pre-defined geographic location. In one embodiment, parking management program 112 determines a new parking space within the pre-defined geographic location by determining a cluster of distribution points based, at least in part, on a plurality of autonomous vehicles to be parked within the pre-defined geographic location and locations of each of the plurality of autonomous vehicles within the pre-defined geographic location, and further define a centroid of the cluster distribution. In one embodiment, parking management program 112 determines a cluster of distribution points utilizing, for example, K-means clustering to obtain the centroid of the cluster. In one embodiment, parking management program 112 references road information from a high definition (HD) map database and generates a list of candidate roadways within a pre-determined range from the centroid of the cluster distribution. In one embodiment, parking management program 112 filters the listed candidate roadways based on a plurality of road attributes including, but not limited to, a type of roadway, a number of lanes on the roadway, a width of the roadway, and a length of the roadway. In one embodiment, parking management program 112 selects a candidate roadway from the list of candidate roadways to create a new parking space based, at least in part, on a location of an autonomous vehicle requesting to be parked. In one embodiment, parking management program 112 predicts a rate of congestion by considering a potential parking space on a candidate roadway by referencing travel history of an autonomous vehicle from a vehicle travel information database and selects a new parking space on a roadway that would cause the least impact (i.e., least increase) on traffic congestion. In one embodiment, parking management program 112 writes information of the new parking space in the parking space database and flags the new parking space for allocation.

Parking management program 112 determines an autonomous vehicle to be parked (206). In one embodiment, parking management program 112 determines an autonomous vehicle to be parked within the pre-defined geographic location by retrieving user profiles and user preferences from a vehicle service database to identify one or more autonomous vehicles requesting a parking space. In one embodiment, parking management program 112 obtains information (e.g., parking requests, parking states, parking space allocations, locations, waiting start time, and waiting end time) of the autonomous vehicles targeted for service from the vehicle service database. In one embodiment, parking management program 112 generates a list of autonomous vehicles to be parked that have not received an allocation for a parking space (e.g., either existing parking space or new parking space) based, at least in part, on parking requests, parking states, parking space allocations, waiting start time, and waiting end time from the autonomous vehicles targeted for parking services. In one embodiment, parking management program 112 may predict a new autonomous vehicle to be parked in the future by obtaining historical information of prior parking requests from vehicle service information stored in the vehicle service database and generate a time series prediction of a number of autonomous vehicles requesting parking. In one embodiment, parking management program 112 selects an autonomous vehicle from the list of autonomous vehicles to be parked that have not received an allocation for a parking space based, at least in part, on historical information of prior parking requests, vehicle service information for the autonomous vehicles, and a proximity of the autonomous vehicles to the selected parking space.

Parking management program 112 selects at least one parking space from the plurality of parking spaces (208). In one embodiment, parking management program 112 retrieves parking space information from a parking space database, where the parking space information includes both existing available parking spaces flagged for allocation and new parking spaces flagged for allocation. In one embodiment, parking management program 112 identifies existing parking spaces flagged for allocation and new parking spaces flagged for allocation that have yet to be allocated to an autonomous vehicle and selects these parking spaces from the plurality of parking spaces in the parking space database. In one embodiment, parking management program 112 obtains a number of autonomous vehicles traveling within a pre-defined proximity to the unallocated parking space based, at least in part, on traffic information and prediction information referenced in the traffic information/prediction information database and the vehicle travel information database. In one embodiment, parking management program 112 selects a new parking space on a candidate roadway based, at least in part, on an impact rating on traffic congestion caused by the selected new parking space. In one embodiment, parking management program 112 determines an impact rating for the selected new parking space on the candidate roadway by analyzing traffic speed as an indicator of traffic congestion by predicting an effect of the selected parking space on the candidate roadway and setting the selecting parking space up as a load value with having a certain impact on the candidate roadway. In one embodiment, parking management program 112 may determine an impact rating of the selected new parking space on the candidate roadway as high impact (e.g., the selected new parking space would significantly increase traffic congestion on the candidate roadway), medium impact (e.g., the selected new parking space would moderately increase traffic congestion on the candidate roadway), and low impact (e.g., the selected new parking space would not increase traffic congestion on the candidate roadway). In one embodiment, parking management program 112 selects a new parking space utilizing rule-based constraints including, but not limited to, selecting a new parking space from a plurality of parking spaces that has the least impact on traffic congestion on the candidate roadway. In one embodiment, parking management program 112 updates an allocation state of the unallocated parking spaces to being selected for allocation in the parking space database.

Parking management program 112 allocates the selected parking space to the autonomous vehicle (210). In one embodiment, parking management program 112 requests information for a selected parking space from the parking space database and queries the vehicle service database for one or more autonomous vehicles with a request to be parked. In one embodiment, parking management program 112 generates a list of the one or more autonomous vehicles with a request to be parked around the selected parking space and based, at least in part on a proximal location of the one or more autonomous vehicles to the selected parking space, allocates at least one of the autonomous vehicles to the selected parking space. In one embodiment, parking management program 112 records the parking space allocation of the one or more autonomous vehicles allocated to the selected space in the vehicle service database and the parking space database accordingly.

Parking management program 112 transmits parking space information and vehicle service information to the autonomous vehicle (212). In one embodiment, parking management program 112 retrieves parking space information from a parking space database and transmits the parking space information to an autonomous vehicle, such as client device 108 and client device 110. In one embodiment, parking management program 112 retrieves parking space allocation information from a vehicle service database and transmits the parking space information (i.e., parking space allocation information) to an autonomous vehicle, such as client device 108 and client device 110. In one embodiment, parking management program 112 transmits the parking space information and the vehicle service information to the autonomous vehicle, such as client device 108 and client device 110, and based, at least in part, on the parking space information and the vehicle service information, further instructs the autonomous vehicle to locate to the selected parking space allocated to the autonomous vehicle and park within the selected parking space.

In an alternative embodiment, responsive to receiving parking space information and vehicle service information, parking management program 112 instructs each of the autonomous vehicles, such as client device 108 and client device 110, to add the parking space information as an impassable space to road information stored locally on a database. In one embodiment, where parking management program 112 determines, based at least in part, on the parking space information and vehicle service information, that the allocated parking space is not currently occupied by an additional autonomous vehicle, parking space management program 112 instructs the autonomous vehicle, such as client device 108 and client device 110, to set a travel route from a current location to the allocated parking space, and instructs the autonomous vehicle to depart on the travel route to the allocated parking space. In one embodiment, responsive to the autonomous vehicle arriving at the allocated parking space, parking management program 112 instructs the autonomous vehicle to retrieve geographical dimension information and inter-vehicle distance information for the allocated parking space from the parking space information. In one embodiment, responsive to determining that an inter-vehicle distance (e.g., a default inter-vehicle distance from a center position of the allocated parking space) within the geographical dimensions of the allocated parking space exceeds a parking space threshold (e.g., an area greater than a maximum exterior dimension of the autonomous vehicle), parking management program 112 instructs each of the autonomous vehicles to locate to a center position of the allocated parking space. In one embodiment, the geographical dimensions of the allocated parking space are made as small as possible to minimize negative impacts on traffic (e.g., congestion). In one embodiment, responsive to the autonomous vehicle locating to the center position of the allocated parking space, parking management program 112 instructs the autonomous vehicle to transmit a state of vehicle location, a parking request, a parking state, a parking space allocation, a waiting start time, and a waiting end time as vehicle service information back to parking management program 112 to provide real-time information regarding the state of the allocated parking space. In one embodiment, responsive to an autonomous vehicle, such as client device 108 and client device 110 departing from the allocated parking space, parking management program 112 instructs any remaining additional autonomous vehicles forward or rearward of the autonomous vehicle to automatically relocate toward the center position of the allocated parking space vacated by the autonomous vehicle, all while maintaining a default inter-vehicle distance.

In some embodiments, the aforementioned steps of the above referenced alternative embodiment may be performed by an autonomous vehicle utilizing one or more integrated vehicle components, including, but not limited to, a parking space control component, a parking space information/vehicle service information receiving component, and a vehicle information/vehicle service information transmitting part, capable of communicating with one or more additional integrated vehicle components known in the art, including, but not limited to, a travel control device, a path planner component, a route navigation component, and a self-position estimation component.

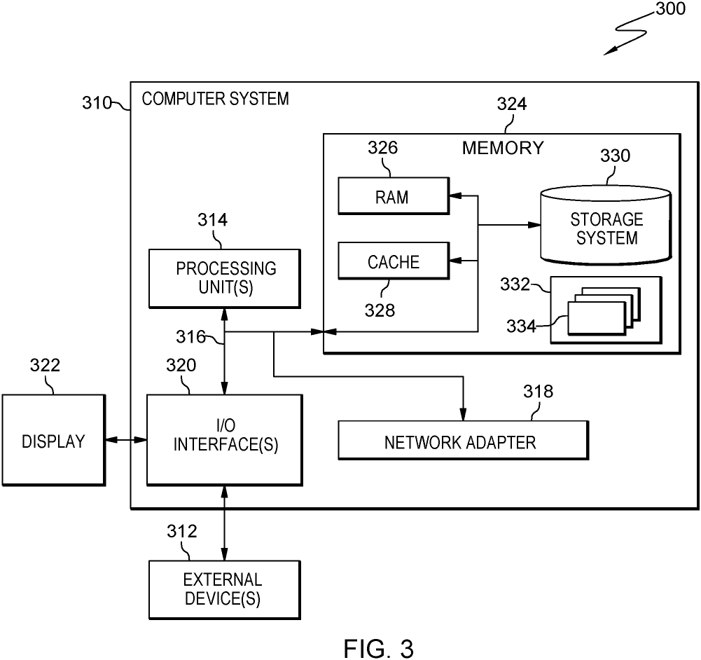

FIG. 3 is a block diagram depicting components of a data processing environment, such as server 104 of data processing environment 100, generally designated 300, in accordance with an embodiment of the present invention. It should be appreciated that FIG. 3 provides only an illustration of one implementation and does not imply any limitations with regard to the environments in that different embodiments may be implemented. Many modifications to the depicted environment may be made.

In the illustrative embodiment, server 104 in data processing environment 100 is shown in the form of a general-purpose computing device, such as computer system 310. The components of computer system 310 may include, but are not limited to, one or more processors or processing unit(s) 314, memory 324 and bus 316 that couples various system components including memory 324 to processing unit(s) 314.

Bus 316 represents one or more of any of several types of bus structures, including a memory bus or memory controller, a peripheral bus, an accelerated graphics port and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus and Peripheral Component Interconnect (PCI) bus.

Computer system 310 typically includes a variety of computer system readable media. Such media may be any available media that is accessible by computer system 310 and it includes both volatile and non-volatile media, removable and non-removable media.

Memory 324 can include computer system readable media in the form of volatile memory, such as random access memory (RAM) 326 and/or cache memory 328. Computer system 310 may further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk, such as a CD-ROM, DVD-ROM or other optical media can be provided. In such instances, each can be connected to bus 316 by one or more data media interfaces. As will be further depicted and described below, memory 324 may include at least one computer program product having a set (e.g., at least one) of program modules that are configured to carry out the functions of embodiments of the invention.

Program/utility 332, having one or more sets of program modules 334, may be stored in memory 324 by way of example and not limitation, as well as an operating system, one or more application programs, other program modules and program data. Each of the operating systems, one or more application programs, other program modules and program data or some combination thereof, may include an implementation of a networking environment. Program modules 334 generally carry out the functions and/or methodologies of embodiments of the invention as described herein. Computer system 310 may also communicate with one or more external device(s) 312, such as a keyboard, a pointing device, a display 322, etc. or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks, such as a local area network (LAN), a general wide area network (WAN) and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives and data archival storage systems may be used in conjunction with computer system 310.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams and combinations of blocks in the flowchart illustrations and/or block diagrams, can be implemented by computer readable program instructions.

These computer readable program instructions may be provided to a processor of a general purpose computer, a special purpose computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus or other device to cause a series of operational steps to be performed on the computer, other programmable apparatus or other device to produce a computer implemented process, such that the instructions which execute on the computer, other programmable apparatus or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A computer-implemented method comprising:
determining, by one or more computer processors, a plurality of parking spaces on a roadway within a pre-defined geographic location, wherein the plurality of parking spaces are available parking spaces on a side of the roadway;
determining, by the one or more computer processors, a plurality of autonomous vehicles to be parked within the pre-defined geographic location;
allocating, by the one or more computer processors, a selected parking space from the plurality of parking spaces to an autonomous vehicle of the plurality of autonomous vehicles; and
transmitting, by the one or more computer processors, parking space information to the autonomous vehicle, wherein the parking space information includes the selected parking space.

2. The computer-implemented method of claim 1, further comprising:
instructing, by the one or more computer processors, the autonomous vehicle to set a travel route from a current location to the selected parking space; and
instructing, by the one or more computer processors, the autonomous vehicle to depart on the travel route the selected parking space.

3. The computer-implemented method of claim 2, further comprising:
responsive to the autonomous vehicle arriving at the selected parking space, determining, by the one or more computer processors, inter-vehicle distance information and geographical dimension information for the selected parking space;
responsive to a determination that an inter-vehicle distance from a center position of the selected parking space exceeds an exterior dimension of the autonomous vehicle, instructing, by the one or more computer processors, the autonomous vehicle to locate to the center position of the selected parking space; and
instructing, by the one or more computer processors, the autonomous vehicle at the center position of the selected parking space to transmit vehicle service information, wherein the vehicle service information includes a state of vehicle location and the selected parking space.

4. The computer-implemented method of claim 1, wherein determining the plurality of parking spaces on the roadway, further comprises:
determining, by the one or more computer processors, whether there are one or more existing available parking spaces on the roadway;
responsive to a determination that there are one or more existing available parking spaces on the roadway, predicting, by the one or more computer processors, a rate of congestion by considering the one or more existing available parking spaces and associated travel history data; and
responsive to a determination that the rate of congestion is below an acceptable congestion threshold, flagging, by the one or more computer processors, the one or more existing available parking spaces for allocation.

5. The computer-implemented method of claim 4, further comprising:
responsive to a determination that there are no existing available parking spaces on the roadway, determining, by the one or more computer processors, a new parking space.

6. The computer-implemented method of claim 5, wherein determining the new parking space further comprises:
determining, by the one or more computer processors, a cluster of distribution points based, at least in part, on a location of the plurality of autonomous vehicles to be parked within the pre-defined geographic location;
determining, by the one or more computer processors, a centroid of the cluster of distribution points;
generating, by the one or more computer processors, a list of candidate roadways within a pre-determined proximity to the centroid;
selecting, by the one or more computer processors, a new roadway from the list of candidate roadways; and
selecting, by the one or more computer processors, the new parking space on the new roadway based, at least in part, on the rate of congestion.

7. The computer-implemented method of claim 1, wherein determining the plurality autonomous vehicles to be parked within the pre-defined geographic location further comprises:
retrieving, by the one or more computer processors, a plurality of user profiles and one or more user preferences from a vehicle service database to identify the plurality of autonomous vehicles requesting a parking space;
generating, by the one or more computer processors, a list of the plurality of autonomous vehicles requesting to be parked that have not received an allocation for the selected parking space; and
selecting, by the one or more computer processors, the autonomous vehicle from the list of the plurality of autonomous vehicles requesting to be parked that has not received the allocation for the selected parking space based, at least in part, on historical information of prior parking requests, vehicle service information for the autonomous vehicle, and a proximity of the autonomous vehicle to the selected parking space.

8. The computer-implemented method of claim 1, wherein allocating the selected parking space from the plurality of parking spaces to the autonomous vehicle of the plurality of autonomous vehicles further comprises:
requesting, by the one or more computer processors, information for the selected parking space from a parking space database;
generating, by the one or more computer processors, a list of the plurality of autonomous vehicles with a request to be parked based, at least in part on a proximal location of the plurality of autonomous vehicles to the selected parking space; and
querying, by the one or more computer processors, a vehicle service database for the autonomous vehicle with a request to be parked.

9. A computer program product comprising:
one or more computer readable storage media and program instructions stored on the one or more computer readable storage media, the stored program instructions comprising:
program instructions to determine a plurality of parking spaces on a roadway within a pre-defined geographic location, wherein the plurality of parking spaces are available parking spaces on a side of the roadway;
program instructions to determine a plurality of autonomous vehicles to be parked within the pre-defined geographic location;
program instructions to allocate a selected parking space from the plurality of parking spaces to an autonomous vehicle of the plurality of autonomous vehicles; and
program instructions to transmit parking space information to the autonomous vehicle, wherein the parking space information includes the selected parking space.

10. The computer program product of claim 9, the stored program instructions further comprising:
program instructions to instruct the autonomous vehicle to set a travel route from a current location to the selected parking space; and
program instructions to instruct the autonomous vehicle to depart on the travel route the selected parking space.

11. The computer program product of claim 10, the stored program instructions further comprising:
program instructions to, responsive to the autonomous vehicle arriving at the selected parking space, determine inter-vehicle distance information and geographical dimension information for the selected parking space;
program instructions to, responsive to a determination that an inter-vehicle distance from a center position of the selected parking space exceeds an exterior dimension of the autonomous vehicle, instruct the autonomous vehicle to locate to the center position of the selected parking space; and
program instructions to instruct the autonomous vehicle at the center position of the selected parking space to transmit vehicle service information, wherein the vehicle service information includes a state of vehicle location and the selected parking space.

12. The computer program product of claim 9, wherein the program instructions to determine the plurality of parking spaces on the roadway further comprise:
program instructions to determine whether there are one or more existing available parking spaces on the roadway;
program instructions to, responsive to a determination that there are one or more existing available parking spaces on the roadway, predict a rate of congestion by considering the one or more existing available parking spaces and associated travel history data; and
program instructions to, responsive to a determination that the rate of congestion is below an acceptable congestion threshold, flag the one or more existing available parking spaces for allocation.

13. The computer program product of claim 12, the stored program instructions further comprising:
program instructions to, responsive to a determination that there are no existing available parking spaces on the roadway, determine a new parking space.

14. The computer program product of claim 13, wherein the program instructions to determine the new parking space further comprise:
program instructions to determine a cluster of distribution points based, at least in part, on a location of the plurality of autonomous vehicles to be parked within the pre-defined geographic location;
program instructions to determine a centroid of the cluster of distribution points;
program instructions to generate a list of candidate roadways within a pre-determined proximity to the centroid;
program instructions to select a new roadway from the list of candidate roadways; and
program instructions to select the new parking space on the new roadway based, at least in part, on the rate of congestion.

15. The computer program product of claim 9, wherein the program instructions to determine the plurality of autonomous vehicles to be parked within the pre-defined geographic location further comprise:
program instructions to retrieve a plurality of user profiles and one or more user preferences from a vehicle service database to identify the plurality of autonomous vehicles requesting a parking space;
program instructions to generate a list of the plurality of autonomous vehicles requesting to be parked that have not received an allocation for the selected parking space; and
program instructions to select the autonomous vehicle from the list of the plurality of autonomous vehicles requesting to be parked that has not received the allocation for the selected parking space based, at least in part, on historical information of prior parking requests, vehicle service information for the autonomous vehicle, and a proximity of the autonomous vehicle to the selected parking space.

16. The computer program product of claim 9, wherein the program instructions to allocate the selected parking space from the plurality of parking spaces to the autonomous vehicle of the plurality of autonomous vehicles further comprise:
program instructions to request information for the selected parking space from a parking space database;
program instructions to generate a list of the plurality of autonomous vehicles with the request to be parked based, at least in part on a proximal location of the plurality of autonomous vehicles to the selected parking space; and
program instructions to query a vehicle service database for the autonomous vehicle with a request to be parked.

17. A computer system comprising:
one or more computer processors;
one or more computer readable storage media; and
program instructions stored on at least one of the one or more computer readable storage media for execution by at least one of the one or more computer processors, the stored program instructions comprising:
program instructions to determine a plurality of parking spaces on a roadway within a pre-defined geographic location, wherein the plurality of parking spaces are available parking spaces on a side of the roadway;
program instructions to determine a plurality of autonomous vehicles to be parked within the pre-defined geographic location;
program instructions to allocate a selected parking space from the plurality of parking spaces to an autonomous vehicle of the plurality of autonomous vehicles; and
program instructions to transmit parking space information to the autonomous vehicle, wherein the parking space information includes the selected parking space.

18. The computer system of claim 15, the stored program instructions further comprising:
program instructions to instruct the autonomous vehicle to set a travel route from a current location to the selected parking space; and
program instructions to instruct the autonomous vehicle to depart on the travel route the selected parking space.

19. The computer system of claim 18, the stored program instructions further comprising:
program instructions to, responsive to the autonomous vehicle arriving at the selected parking space, determine inter-vehicle distance information and geographical dimension information for the selected parking space;
program instructions to, responsive to a determination that an inter-vehicle distance from a center position of the selected parking space exceeds an exterior dimension of the autonomous vehicle, instruct the autonomous vehicle to locate to the center position of the selected parking space; and
program instructions to instruct the autonomous vehicle at the center position of the selected parking space to transmit vehicle service information, wherein the vehicle service information includes a state of vehicle location and the selected parking space.

20. The computer system of claim 17, wherein the program instructions to determine the plurality of parking spaces on the roadway further comprise:
program instructions to determine whether there are one or more existing available parking spaces on the roadway;
program instructions to, responsive to a determination that there are one or more existing available parking spaces on the roadway, predict a rate of congestion by considering the one or more existing available parking spaces and associated travel history data; and
program instructions to, responsive to a determination that the rate of congestion is below an acceptable congestion threshold, flag the one or more existing available parking spaces for allocation.
